(19) United States
(12) Patent Application Publication
(10) Pub. No.: US 2002/0114869 A1
(43) Pub. Date: Aug. 22, 2002

(54) Milk-and-sugar based powder product, method and uses

(75) Inventor: Ricardo Alberto Cravero, Sunchales (AR)

Correspondence Address: DARBY & DARBY P.C., 805 Third Avenue, New York, NY, 10022, US

(73) Assignee: SANCOR COOPERATIVAS UNIDAS LTDA.

(21) Appl. No.: 10/035,038

(22) Filed: Dec. 26, 2001

(30) Foreign Application Priority Data
Dec. 29, 2000 (AR) P 00 01 07033

(51) Int. Cl. A23G 1/00

(52) U.S. Cl. 426/103

(57) ABSTRACT

A milk caramel powder product obtained from drying a milk caramel product based in milk and sugar cooked together, the powder product containing high molecular weight polysaccharides in an amount between about 3 wt % and about 40 wt % of the total weight of the solids present in the product, and having about 1% to about 7% humidity. The inventive products may be used directly, by reconstitution thereof by moistening of the powder, for domestic or industrial applications. The product may be used alone or combined with any proper additive. A method for obtaining the powder product is also provided.

### BACKGROUND OF THE INVENTION

1. Field of the Invention.

The present invention relates to a food product based in milk and sugar cooked together and, more particularly the invention refers to a powder product obtained from drying a creamy product widely known, among other names as “milk caramel”, the inventive powder product containing high molecular weight polysaccharides in an amount between about 3 wt % and about 40 wt % of the total weight of the solids present in the product, and having about 1% to about 7% humidity. The inventive products may be used directly, by reconstitution thereof by moistening of the powder, for application in toasts, as a topping in pastry and confectionery and indirectly, in the food industry and also in applications for pastry and confectionery. The product may be used alone or combined with any proper additive.

The term “milk caramel” encompass such products also know by other names, which will also be used indistinctly along this specification, like caramel spread, milk caramel spread, milk jam, as well as “cajeta de leche” as named in Mexico, or “dulce de leche” as called in Argentina. This product generally has a creamy consistency and is a flowable and pourable product.

2. Description of the Prior Art.

It is well known in some countries, particularly in latinamerican countries and more particularly in Argentina, to consume a most popular product called “dulce de leche”, that basically consists of a product prepared by cooking milk and sugar and stirring the mixture until obtaining a brown creamy, pourable, flowable and spreadable product. This popular product is widely used for spreading on bread toasts with butter, to cover pies, cakes and several bakery products, for covering, as a topping, and filling, food products and meals in pastry and confectionery, and in a lots of applications in the food industry.

The growing market for this product in the last years has caused many improvements in the procedures for obtaining different types of the product and several other applications. Today, it is used in the world for ice creams, pies, cakes, candies, flavored milks, fillers and other food products. While many improvements in the quality and characteristics of the product have been carried out, there is not yet a reliable method for conserving and preserving the milk-based product during long periods of time.

Since this product must have different characteristics, like consistency, fluency, etc. depending on the use thereof, the product must be modified from a basic creamy product according to the application field on which the product will be used. This modification or adaptation of the product generally is made in situ, namely in the food manufacturing plant wherein the product will be used.

When a pastry plant needs to use this creamy product with an enough consistency for applying in the food product, the company must obtain a pastry product that differs from the creamy product typically commercialized in the market. To satisfy the different clients, the creamy product manufacturer, generally a dairy company, must alter the manufacturing conditions depending on the type of product ordered by the several clients using the product for toppings, mousse, fillers for pastry, shakes, ice creams, etc. It is well known for any person skilled in the art, that these alterations in the manufacturing process of an industry leads to higher production costs and delays in the production process.

In addition to the foregoing, the problems remains when large quantities of this product must be transported from the producing plant to the consumers. Since the creamy product, even the more consistent type of product, has an important water content, the product is heavy and thus the transportation thereof is costly.

It would be therefore convenient to have a powder product based in the well known “dulce de leche”, that is the milk-and-sugar based creamy product, with the powder product being capable of being conserved and preserved during long periods of time and capable of being reconstituted to prepare a large variety of several types of the wet product for use in the different domestic and industrial applications.

It would also be necessary to have a process for obtaining the above powder product by eliminating about 30% water content of the typical creamy product, thus obtaining a product lighter than the traditional one, useful for reducing the transportation costs, and increasing the shelf life of the product.

### SUMMRY OF THE INVENTION

It is therefore one object of the present invention to provide a milk caramel powder food product obtained by cooking, under heating conditions, at least milk and sugar until obtaining a creamy product, the powder product containing at least a high molecular weight polysaccharide in an amount between 3 and 40 wt % relative to the weight of solids in the powder, and a humidity between 1 and 7%.

It is also one object of the present invention to provide a milk caramel powder food containing at least a high molecular weight polysaccharide in an amount between 3 and 40 wt % relative to the weight of solids in the powder, and a humidity between 1 and 7%, the polysaccharide being selected from starch, modified starch, equivalent dextrose maltodextrin lower than 20 (DE<20), gum arabic, and combinations thereof.

It is even another object of the present invention to provide a milk caramel powder food containing at least a high molecular weight polysaccharide in an amount between 3 and 40 wt % relative to the weight of solids in the powder, a humidity between 1 and 7%, and at least one additive selected from anti-foamers, anti-moisteners, anti-agglutinants, anti-oxidants, colorants, sweeteners, thickeners, gelificants, stabilizers, aromatizers, flavorizers, moister additives, acidity controllers, emulsion agents, emulsifiers, flavor enhancers, chemical leaning agents, consistency agents, hardeners, texture agents, sequesters, color stabilizers and foaming additives.

It is still another object of the present invention to provide a process for obtaining a powder of “dulce de leche” food product, the method comprising the steps of:

i) cooking together at least milk and sugar until obtaining a creamy product having between about 30 wt % and about 60 wt % solids for prepare a basic “dulce de leche”,

ii) pasteurizing the creamy product at a temperature of between about 50° C. and about 85° C.,

iii) homogenizing the pasteurized creamy product at a pressure between about 5 kg/cm² and about 100 kg/cm²,

iv) adding to the mixture a high molecular weight polysaccharide before, simultaneously with, or after any of the above steps, in an amount of between about 3 wt % and about 40 wt % of the total dry weight, and

v) drying and agglomerating the mixture until obtaining a powder having between about 1% and about 7% moisture.

It is a further object of the present invention to provide a process for obtaining a powder food product from “dulce de leche” product having between about 30 wt % and about 60 wt % solids, the method comprising the steps of:

i) pasteurizing the creamy product at a temperature of between about 50° C. and about 85° C.,

ii) homogenizing the pasteurized creamy product at a pressure between about 5 kg/cm² and about 100 kg/cm²,

iii) adding to the mixture a high molecular weight polysaccharide before, simultaneously with, or after any of the above steps, in an amount of between about 3 wt % and about 40 wt % of the total dry weight, and

iv) drying and agglomerating the mixture until obtaining a powder having between about 1% and about 7% moisture.

It is a further object of the present invention to provide a process for obtaining a powder food product from “dulce de leche” product having between about 30 wt % and about 60 wt % solids, the method comprising the steps of drying the creamy product by a method selected from spray drying, liophylization, and rolling drying.

It is a further object of the present invention to provide a process for obtaining a powder food product from “dulce de leche” product having between about 30 wt % and about 60 wt % solids, the method comprising the steps of drying the creamy product to obtain the powder and add at least one additive to the powder product obtained, the additive being preferably added by mixing and agglomerating the same with the powder product thus obtaining an instantaneous dissolving powder product, or the additive is added to the creamy product before, during or after the drying step.

It is even another object of the present invention to provide an use of the inventive powder food product, wherein the powder product is mixed with lecithin and partially dehydrogenated fat for obtaining a cover topping for pastry and confectionery, or the powder product is mixed with starch, partially dehydrogenated fat and caramel colorant for obtaining a filler for pastry and confectionery, or the powder product is mixed with partially dehydrogenated fat and sugar for obtaining a creamy filler for pastry and confectionery, or the powder product is mixed with demineralized whey, partially dehydrogenated fat and sugar for obtaining a spreading paste, or the powder product is mixed with powder whey, powder skimmed milk, an emulsifier and sugar, for obtaining a mousse, or the powder product is mixed with stabilizers, emulsifiers, powder milk, powder skimmed milk, and sodium citrate for obtaining a shake product, or water is added to the powder product for obtaining a reconstituted creamy product with a moisture content of between about 10% and about 30%.

The above and other objects, features and advantages of this invention will be better understood when reading the following detailed description.

### DESCRIPTION OF THE PREFERRED EMBODIMENTS

The invention provides a milk caramel powder food product obtained by drying a typical creamy product. The creamy product is typically obtained by cooking, under heating conditions, a mixture of at least milk and sugar until obtaining such a creamy product, generally a brown creamy product or jam. The inventive powder product contains at least a high molecular weight polysaccharide in an amount between 3 and 40 wt % relative to the weight of solids in the powder, and an humidity between 1 and 7% and more preferably less than 3% humidity.

The high molecular weight polysaccharide is preferably selected from starch, modified starch, equivalent dextrose maltodextrine lower than 20 (DE<20), gum arabic, and combinations thereof.

The powder product of the invention may also include anti foam additives such as calcium alginate, anti moistening additives and anti-coagulants such as aluminum silicate, silicon dioxide and micro crystalline cellulose; anti oxidants such as ascorbic acid, sodium and calcium ascorbate and tocopherol; colorants like caramel III; sweeteners such as sucralose, aspartame, saccharin and its sodium, potassium and calcium salts; thickeners such as gum guar and gum xantic; gelatinizing agents such as edible gelatin, carragheenan, amide pectin; stabilizers such as carboxymethyl cellulose, sodium alginates; aroma and flavor additives such as vanillin, ethyl vanillin; moisteners such as sorbitol and xylitol; acidity regulators such as sodium carbonate and acid sodium carbonate; emulsifiers such as calcium polyphosphate and calcium polyphosphate; flavor enhancers such as mono sodium glutamate and aspartame; chemical leavening agents such as sodium carbonate, acid sodium carbonate and neutral potassium pyrophosphate; consistency agents or hardeners such as polydextrose and sorbitol; sequesters such as sodium citrate and sodium and potassium phosphates; color stabilizers such as calcium/potassium nitrate, calcium/potassium nitrites, and magnesium hydroxide; and foam forming agents such as methyl ethyl cellulose. As it will be apparent for any expert in the art, any other additive for the food industry may also be used without departing from the spirit and scope of the invention.

The product of the invention has the following properties:

It is a powder with an humidity between about 1% and about 7%, preferably below 3%.

It has the characteristic color and flavor of the original creamy product, that is it conserves all the organoleptic features of the wet original product.

It has a high solubility, namely a solubility index 1.5 ml maximum, according to ADPI Bulletin 916-1990.

It has a good capability of being wetted, maximum 120 seconds according to FIL 87-1979.

It has an optimum hygroscopicity and preserves the flavor and aroma stable.

It has optimum fluidity, maximum 120 seconds according to reference method A 24a, Niro Atomizer.

It is micro biologically stable under normal environmental conditions and has an instantaneous dissolution.

It has an apparent density of from 0.10 g/ml to 0.65 g/ml, according to FIL 134 A-1995.

Furthermore, the inventive product has important food properties such as for the provision of energy and proteins.

The product of the invention may be used for direct consumers or indirectly by using the same as an ingredient in the elaboration of food products. The inventive product may be used in the elaboration of ice creams, flan, desserts, sweets, confectionery in general, it can be mixed with vegetal fats with specific melting points and sugar. By properly selecting the amounts and characteristics of the melting point of the vegetal fats, covers as toppings, with particular rheologic properties may be obtained for specific uses. It is also possible to use the inventive product in the preparation of mixtures of instantaneous powders for preparing beverages, cakes, ice creams, desserts, gelatins, mousse and other products widely used at home; fillers with low water activity for the preparation of cakes, pastry, bakery, cookies, chocolates; cream-type fillers capable of resisting high temperatures for pastry and bakery; spreadable paste with low water activity; nougats, chocolates, shakes. The inventive product may also be used as a flavorant.

The process according to the invention for obtaining a powder product, based on a milk and sugar mixture, comprises at least a first step of making a basic mixture of milk and sugar cooked together to obtain a creamy product having between about 30 wt % to about 60 wt % solids. This mixture with such a solids concentration may be prepared by diluting a highly concentrated mixture having 60 wt % to 90 wt % solids and containing all the typical components. In any event, the method of the invention may include the step of preparing the original or basic creamy mixture or product or may use a creamy product already prepared by classical methods.

According to the invention, polysaccharides having a high molecular weight are added to the basic or original mixture during, after or before its preparation. These polysaccharides may be added to the product of the invention at any step of the process before the drying of the product. The addition of this or these polysaccharides is made before, simultaneously with, or after any of the steps of the inventive method, preferably in an amount of between about 3 wt % and about 40 wt % of the total solids weight. Preferably, the addition of the polysaccharide is made at the end of step of cooking the milk and sugar, when obtaining the basic or original creamy product, if this step is part of the method. If the creamy product is already obtained, the addition of the polysaccharide is made at the beginning of the inventive process before the drying step.

Preferably, the polysaccharide having a high molecular weight is selected from starch, modified starch, equivalent dextrose maltodextrin lower than 20 (DE<20), gum arabic, and/or combinations thereof.

In another step of the method of the invention the creamy mixture or product is pasteurized at a temperature of between about 50° C. and about 85° C., preferably at 70° C., in a heat interchanging equipment. As any expert in the art may be aware, any heat interchanging apparatus may be used for the purposes of the invention.

In a subsequent step, the pasteurized creamy product or mixture is pumped and homogenized at a pressure between about 5 kg/cm² and about 100 kg/cm². The pasteurization, pumping and homogenization are very important for the subsequent drying step because the combination of temperature and pressure gives the basic mixture the fluid-dynamic properties for allowing the proper drying of the basic creamy mixture.

Finally, the creamy mixture is dried and agglomerated until obtaining a powder having between about 1 % and about 7 % moisture. This drying step may be carried out in only one step, or two or three steps, by any conventional drying method, preferably a method used in the food industry, such as spray drying, lyophilization, or rolling drying.

For obtaining the classical smell and flavor of the typical creamy product “dulce de leche” the typical and natural volatile components of the creamy product that are given off during the preparation of the creamy product may be re-added to the mixture. These volatile components may be recovered during the process of the invention by a process that include condense and distillation of steams, and may be added to the final powder product. In other words, the volatile components given off during the process are recovered and re-inserted into the mixture.

The additives used and incorporated to the product are selected depending on the final use of the inventive powder product and these additives may be added during the elaboration of the typical, original, basic creamy product or at the end of the inventive process by mixing the powder product of the invention with powder additives. In this event, the inventive powder product will have the minimal basic ingredients and the corresponding additives will be added.

According to the invention, at least one additive is added to the product, and the additive may be any of the following ones or a combination thereof: anti foam agents, anti moisten additives, anti-agglutinants, anti-oxidants, colorants, sweeteners, thickeners, gelatinizing agents, stabilizers, aromatizers, flavorants, moister additives, acidity controllers, emulsion agents, emulsifiers, flavor enhancers, chemical leaning agents, consistency agents, hardeners, texture agents, sequesters, color stabilizers and foaming additives.

The above additives may be added the powder product at the end of the process, or may be added by mixing and agglomerating the additives with the powder product for obtaining an instantaneous dissolving powder product, for example, or the additives may be added to the creamy product before or during the drying step.

According to the use and applications of the final powder product, the drying process may be carried out by continuous injection, in a fluidized medium, of hot air, silicon dioxide in a proportion comprised between about 0.05 % and about 1.5 % in a dry basis, with a subsequent superficial crystallization by pulverization with drops of specific vegetal or animal fats. The combination and selection of temperatures and thermal changes are very important for maintaining within a drying chamber, an integrated fluidized bed and vibrating-fluidizers, the optimum fluid-dynamic properties of the powder, the particles size, the trapped air, and the encapsulation of smell and flavor, and fats. The combination of the above mentioned factors allows one to obtain a powder with the mentioned properties according to the invention, which inventive powder may be packaged in flexible or rigid packages of several capacities, such as lkg, 25 kg, 100 kg, 1000 kg, or more.

The temperature rates employed in the drying procedure of the invention may be, preferably, the following:

Temperature of drying air between about 120° C. and about 280° C.;

Temperature of secondary drying air, for static bed and scavenging of the walls of the chamber, between about 60° C. and about 180° C.;

Temperature of drying air in vibrating fluidizers between about 15° C. and about 120° C.;

Temperature of air exiting the chamber between about 65° C. and about 140°C.; and

Temperature of the powder exiting in the vibrating fluidizers between about 15° C. and about 60° C.

A portion of the product that is considered fine powder is returned to an agglomeration chamber and the returning rate of the fine powder is between about 0% and about 100%.

The powder product of the invention may also be obtained by lyophilization under conditions of low pressure and low temperature, followed by a subsequent dry milling and classification of the obtained product. For improving the properties of the product, silicon dioxide may be added in a proportion comprised between about 0.05% and about 1.5% in dry basis.

While some preferred drying methods have been disclosed it will be obvious to any person skilled in the art that other drying methods already used in the food industry may be employed without departing from the scope of the invention.

The present invention will be better understood when taken in connection with the following examples which are given with no limitative purpose of the scope of the invention but for illustrative purposes.

### EXAMPLE 1

### Production of the Inventive Powder Product

A mixture is prepared with 100 kg of a typical milk caramel creamy product having a solids concentration of 70% on dry basis and 22 Kg of equivalent dextrose maltodextrin lower than 20 (DE<20). The mixture is diluted in water for obtaining a basic mixture having 45% solids in a dry basis. Subsequently, volatile components recuperated or retrieved during the mixing process are re-inserted into the mixture.

The basic mixture is heated at 70° C. in a heat interchanging device, for 20 minutes. The mixture is then pumped and homogenized at a pressure of 80 kg/cm² and the obtained product is dried by a spray drying system until obtaining a powder having less than 3% humidity. The drying process in the drying system is carried out under the following conditions:

Temperature of drying air 190° C.;

Temperature of secondary drying air, for static bed and scavenging of the walls of the chamber, 70° C.;

Temperature of drying air in vibrating fluidizers 60° C.;

Temperature of air exiting the chamber 90° C.; and

Temperature of the powder exiting the vibrating fluidizers, 20° C.

The production was 87 kg of inventive powder product.

Finally, the powder product was mixed with several additives in a mixer for powders, and the product was divided into fractions in several containers.

This Example may be modified by altering the moment when the maltodextrin is added, thus the maltodextrin may be added during the preparation of the basic mixture together with the addition of the diluent or subsequently in any step before the drying step.

### EXAMPLE 2

### Elaboration of a Topping Cover Using the Inventive Powder Product

5 gr. demineralized whey were added to 63 kg powder product obtained in Example 1, forming a mixture having 68 % powder in a dry basis, and adding 0.4 % lecithin and 32 % partially dehydrogenated fat.

### EXAMPLE 3

### Elaboration of a High Temperature-Resisting Filler Using the Inventive Powder Product

The following two mixtures A and B were prepared:

Mixture A: 50 gr. inventive powder product as obtained in Example 1 and 6 gr. powder milk.

Mixture B: 3 gr. inventive powder product as obtained in Example 1 and 1 gr. starch.

A mixture was prepared having, on a dry basis, mixture A 56%, mixture B 4%, partially dehydrogenated fat 35% and caramel colorant 1%.

### EXAMPLE 4

### Elaboration of a Creamy Filler Using the Inventive Powder Product

A mixture was prepared containing, on a dry basis, inventive powder product as obtained in Example 1 10%, sugar 45% and partially dehydrogenated fat 45%.

### EXAMPLE 5

### Elaboration of a Spreadable Paste Using the Inventive Powder Product

2.2 gr. demineralized whey was added to 26.8 gr. inventive powder product as obtained in Example 1, forming a mixture having 29% powder in a dry basis, and adding 41% refined sugar and 30% partially dehydrogenated fat.

### EXAMPLE 6

### Elaboration of a Powder for Preparing Mousse, Using the Inventive Powder Product

5 gr. emulsifier, glyceryl monostearate, and 7 gr. powder whey were added to 72.5 gr. inventive powder product as obtained in Example 1, forming a mixture having 84.5% powder in a dry basis, and adding 9% sugar and 6.5% powder skimmed milk.

### EXAMPLE 7

### Elaboration of a Shake Product Using the Inventive Powder Product

1.5 gr. stabilizer, sodium alginate, and 2 gr. emulsifier, glyceryl monostearate, were added to 7 gr. inventive powder product as obtained in Example 1, forming a mixture having 11.4% powder in a dry basis, and adding 78% sugar, 4.5% powder skimmed milk, 5.5% powder milk and 0.6% sodium citrate.

While preferred embodiments of the present invention have been illustrated and described, it will be obvious to those skilled in the art that various changes and modifications may be made therein without departing from the scope of the invention as defined in the appended claims.

We claim:

1. A powder food product obtained from drying a milk caramel product, the powder product containing at least a high molecular weight polysaccharide in an amount of between about 3 wt % and about 40 wt % relative to the weight of solids in the powder, and a humidity between about 1 and about 7%.

2. The powder product of claim 1, wherein high molecular weight polysaccharide is selected from starch, modified starch, equivalent dextrose maltodextrin lower than 20 (DE<20), gum arabic, and combinations thereof.

3. The powder product of claim 1, further comprising at least one additive selected from anti foam agents, anti-moisteners, anti-agglutinants, anti-oxidants, colorants, sweeteners, thickeners, gelatinizing agents, stabilizers, aromatizers, flavorants, moister additives, acidity controllers, emulsion agents, emulsifiers, flavor enhancers, chemical leaning agents, consistency agents, hardeners, texture agents, sequesters, color stabilizers and foaming additives.

4. The powder product of claim 1, wherein the powder product has an apparent density of between 0.1 g/ml and 0.65 g/ml, a maximum solubility index of 1.5 ml and a maximum fluidity of 120 seconds.

5. A process for obtaining a powder food product based on milk caramel, the method comprising the steps of:
i) cooking together at least milk and sugar until obtaining a milk caramel product having between about 30 wt % and about 60 wt % solids,
ii) pasteurizing the milk caramel product at a temperature of between about 50° C. and about 85° C.,
iii) homogenizing the pasteurized milk caramel product into a mixture at a pressure between about 5 kg/cm² and about 100 kg/cm²,
iv) adding to the mixture a high molecular weight polysaccharide before, simultaneously with, or after any of the above steps, in an amount of between about 3 wt % and about 40 wt % of the total dry weight, and
v) drying and agglomerating the mixture until obtaining a powder having between about 1% and about 7% moisture.

6. The method of claim 5, wherein the addition of the polysaccharide is made at the beginning of step i).

7. The method of claim 5, wherein the addition of the polysaccharide is made during step i).

8. The method of claim 5, wherein the addition of the polysaccharide is made at the end of step i).

9. The method of claim 5, wherein the addition of the polysaccharide is made before, during or after step iii).

10. The method of claim 5, wherein the step of drying is carried out by a method selected from spray drying, lyophilization, and rolling drying.

11. The method of claim 5, further comprising the step of adding at least one additive to the product, the additive being selected from anti foam agents, anti-moisteners, anti-agglutinants, anti-oxidants, colorants, sweeteners, thickeners, gelatinizing agents, stabilizers, aromatizers, flavorants, moister additives, acidity controllers, emulsion agents, emulsifiers, flavor enhancers, chemical leaning agents, consistency agents, hardeners, texture agents, sequesters, color stabilizers and foaming additives.

12. The method of claim 11, wherein the at least one additive is added to the powder product obtained in step v).

13. The method of claim 12, wherein the at least one additive is added by mixing and agglomerating the same with the powder product thus obtaining an instantaneous dissolving powder product.

14. The method of claim 11, wherein the at least one additive is added to the milk caramel product during or after step i).

15. The method of claim 5, wherein volatile components are given off during the process and such components are recovered and re-inserted into the mixture.

16. The method of claim 5, wherein the high molecular weight polysaccharide is selected from starch, modified starch, equivalent dextrose maltodextrine lower than 20 (DE<20), gum arabic, and combinations thereof.

17. Use of the powder food product of claim 1, wherein the powder product is mixed with lecithin and partially dehydrogenated fat for obtaining a cover topping for pastry and confectionery.

18. Use of the powder food product of claim 1, wherein the powder product is mixed with starch, partially dehydrogenated fat and caramel colorant for obtaining a filler for pastry and confectionery.

19. Use of the powder food product of claim 1, wherein the powder product is mixed with partially dehydrogenated fat and sugar for obtaining a creamy filler for pastry and confectionery.

20. Use of the powder food product of claim 1, wherein the powder product is mixed with demineralized whey, partially dehydrogenated fat and sugar for obtaining a spreading paste.

21. Use of the powder food product of claim 1, wherein the powder product is mixed with powder whey, powder skimmed milk, an emulsifier and sugar, for obtaining a mousse.

22. Use of the powder food product of claim 1, wherein the powder product is mixed with stabilizers, emulsifiers, powder milk, powder skimmed milk, and sodium citrate for obtaining a milk caramel shake product.

23. Use of the powder food product of claim 1, wherein water is added to the powder product for obtaining a reconstituted milk caramel product with a moisture content of between about 10% and about 30%.

24. A proces s for obtaining a powder food product from a milk caramel product having between about 30 wt % and about 60 wt % solids, the method comprising the steps of:
i) pasteurizing the milk caramel product at a temperature of between about 50° C. and about 85° C., ii) homogenizing the pasteurized milk caramel product into a mixture at a pressure between about 5 kg/cm² and about 100 kg/cm², iii) adding to the mixture a high molecular weight polysaccharide before, simultaneously with, or after any of the above steps, in an amount of between about 3 wt % and about 40 wt % of the total dry weight, and iv) drying and agglomerating the mixture until obtaining a powder having between about 1% and about 7% moisture.
